(19) United States
(12) Patent Application Publication
(10) Pub. No.: US 2024/0260501 A1
(43) Pub. Date: Aug. 8, 2024

(54) METHOD AND SYSTEM FOR DETERMINING A SOWING ROW DIRECTION

(71) Applicant: BASF AGRO TRADEMARKS GMBH, Ludwigshafen (DE)

(72) Inventor: Marcel Enzo GAUER, Köln (DE)

(21) Appl. No.: 18/565,921

(22) PCT Filed: Jun. 2, 2022
(86) PCT No.: PCT/EP2022/064990

§ 371 Date: Nov. 30, 2023

(30) Foreign Application Priority Data
Jun. 4, 2021 (EP) 21177729.7

(51) Int. Cl. A01B 79/00; A01B 69/00

(52) U.S. Cl. CPC A01B 79/005; A01B 69/001

(57) ABSTRACT

A method for determining a sowing row direction (4) is provided. The method comprises providing location data for at least one location of interest (5), the at least one location of interest (5) being located within an agricultural field (2). The method further comprises providing a sowing row information map (1; 6; 8), the sowing row information map (1; 6; 8) comprising information on the sowing rows (7) of the agricultural field (2) with a sub-field resolution. Finally, the method comprises identifying the sowing row direction (4) at the at least one location of interest (5) based on the sowing row information map (1; 6; 8). Further, a system (14) for determining a sowing row direction (4), a computer program element, a computer readable medium and a system (10) for generating a processed sowing row information map (6; 8) from a sowing track map (1) are provided.

### FIELD OF THE INVENTION

The present invention relates to digital farming. In particular, the present invention relates to a method and a system for determining a sowing row direction. Moreover, the present invention relates to a computer program element and a computer readable medium. Also, the present invention relates to a system for generating a processed sowing row information map from a sowing track map.

### BACKGROUND OF THE INVENTION

In agriculture, many crops, such as corn or soy, are sown in rows. The resulting growth of the plants in sowing rows is used in many ways. As an example, weeds may be detected by examining which plants are not within the sowing rows. As another example, harvesting may be performed along the sowing rows, and as yet another example, tillage may be performed at an angle to the sowing rows.

Commonly, the weed detection is performed by using a camera that takes pictures of sections of the agricultural field and a subsequent analysis of these pictures. For an effective analysis, the angle between a moving direction of a treatment device and the sowing rows has a predetermined value or is entered manually. As an example, the moving direction of the treatment device may be parallel to the sowing rows or the moving direction of the treatment device may be at an angle, e.g., 60°, to the sowing rows. Even if said angle is chosen or entered, there may be instances, in particular at the edges and corners of the agricultural field, where the weed detection is flawed due to a deviation of the actual sowing row direction to the assumed direction.

Also, harvesting along the sowing rows and tilling at an angle to the sowing rows commonly requires an operator to steer the treatment device in the desired direction, which makes said actions prone to human error.

### SUMMARY OF THE INVENTION

It is therefore an object of the present invention to automatically determine the sowing row direction, i.e., to provide a method for determining the sowing row direction.

The object of the present invention is solved by the subject-matter of the independent claims, wherein further embodiments are incorporated in the dependent claims.

According to a first aspect of the invention, a method for determining a sowing row direction is provided. In this context, the sowing row direction is a direction of rows in which crop plants have been arranged, particularly sown. Preferred crops are Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea mays. Most preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N.rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays. Especially preferred crops are crops of cereals, corn, soybeans, rice, oilseed rape, cotton, potatoes, peanuts or permanent crops.

According to the method, location data for at least one location of interest is provided. Said location of interest is the location for which the sowing row direction is to be determined. The location data may be provided as coordinates in the form of latitude and longitude, as open location code or in a location coordinate system. Said location data may be obtained, for example, from a satellite navigation system, such as NAVSTAR GPS, Galileo, GLONASS or Beidou. Alternatively, the location data may be obtained, e.g., by multilateration of mobile radio signals. The location data may be transferred via wired and/or wireless connections.

The location of interest is located within an agricultural field. In this context, “agricultural field” is to be interpreted widely and may also refer to a horticultural field or a silvicultural field. The agricultural field is, in particular, a field where the crop plants are produced.

Further, a sowing row information map is provided. Said sowing row information map comprises information on the sowing rows of the agricultural field with sub-field resolution. In this context, sub-field resolution refers to a resolution being smaller than the dimensions of the agricultural field. Preferably, the sub-field resolution is less than 30 m, more preferably, the sub-field resolution is less than 10 m, particularly preferably, the sub-field resolution is less than 3 m.

According to the method, the sowing row direction at the at least one location of interest is identified. If several locations of interest have been provided, the identification of the sowing row direction is performed for each of said locations of interest. Said identification of the sowing row direction is performed based on the sowing row information map. Based on the sowing row direction obtained by the method, the execution of agricultural methods or treatments that depend on the sowing row direction, such as weed detection, harvesting or tillage, may be improved. Also, if an agricultural method or treatment depended on an operator recognizing the sowing row direction, said agricultural method or treatment may be automated based on the sowing row direction obtained by the method.

According to an embodiment, the sowing row information map is a sowing track map. The sowing track map comprises sowing track data of a sowing machine. Particularly, the sowing track map comprises the track data of the sowing machine when sowing the agricultural field. Said track data may have been recorded from data provided by a satellite navigation system, such as NAVSTAR GPS, Galileo, GLONASS or Beidou or obtained, e.g., by multilateration of mobile radio signals. As an example, the sowing track data may comprise a plurality of locations that were recorded along the track of the sowing machine. The locations may be provided as a time-ordered list such that the track of the sowing machine can be retraced. Additionally or alternatively, the sowing track data may comprise time stamps corresponding to each of the plurality of locations. Preferably, the sowing track data further comprises information on whether or not the sowing machine was sowing while moving on the agricultural field. The information whether or not the sowing machine was sowing may be included in several ways in the sowing track data. As an example, to each of the locations that were recorded along the track of the sowing machine, an identifier is recorded, identifying whether or not the sowing machine was sowing. If the sowing machine comprises a plurality of sowing units that may be individually activated, the information whether or not the sowing machine was sowing may be a list identifying the sowing status for each of the sowing units. Additionally or alternatively, only those tracks of the sowing machine during which the sowing machine was sowing may be recorded. Further information on the sowing machine, such as a layout or a width of the sowing machine, may be recorded as metadata to the sowing track map.

The identification of the sowing row direction at the at least one location of interest based on the sowing track map is performed, in particular, from the direction of the sowing track closest to the at least one location of interest. Finding said sowing track being closest to the at least one location of interest is computationally easy. If the sowing track data also comprises information on whether or not the sowing machine was sowing while moving on the agricultural field, only the sowing tracks during which the sowing machine was sowing will be considered. If, within a predetermined radius around the location of interest, wherein the predetermined radius is, in particular, one half of the width of the sowing machine, no sowing track can be found, it is assumed that there was no sowing at the location of interest and instead of the sowing row direction, a corresponding message will be returned. Also, if, within the predetermined radius more than one sowing track is found and the directions of said sowing tracks differ from one another, it is unclear whether the sowing row follows one or the other direction or whether sowing was performed, for whichever reason, in two directions. Hence, it is also unclear whether sowing was performed in one or the other or both directions and a corresponding message will be returned instead of a sowing row direction.

According to an embodiment, the sowing row information map is a sowing row map. The sowing row map may have been obtained, e.g., from a sowing track map, and comprises data on the sowing rows in the agricultural field. Said data on the sowing rows is, e.g., location data for a plurality of locations along one sowing row.

The identification of the sowing row direction at the at least one location of interest based on the sowing row map is performed, in particular, from the direction of the sowing row closest to the at least one location of interest. Finding said sowing row being closest to the at least one location of interest is computationally easy. If, within a predetermined radius around the location of interest, wherein the predetermined radius is, in particular, the spacing between two sowing rows or one half of the spacing between two sowing rows, no sowing row can be found, it is assumed that there is no sowing row at the location of interest and instead of the sowing direction, a corresponding message will be returned.

According to an embodiment, the sowing row information map is a sowing row direction map. The sowing row direction map may have been obtained, e.g., from a sowing track map, and comprises data on the direction of the sowing rows in the agricultural field. In particular, the agricultural field is divided into a plurality of zones, wherein each zone is, in particular, a polygon, and a sowing row direction is indicated for each of the zones. The sowing row direction is then determined for the location of interest from the sowing row direction indicated for the zone comprising the location of interest.

According to an embodiment, the at least one location of interest is the location of a treatment device. As used herein, the treatment device may be part of a smart farming machinery and may preferably be part of a distributed computing environment. A treatment device may be a driving, flying or any otherwise moving device that travels through or over the agricultural field, such as a ground vehicle, a rail vehicle, an aircraft, a drone, or the like. Further, the smart farming machinery or the treatment device may be, for example, a vehicle, an aircraft, a robot, a sprayer, or the like, with treatment mechanisms attached to it and may comprise a communication and/or connectivity system. The connectivity system may be configured to communicatively couple the treatment device to the distributed computing environment. It may be configured to provide data collected on the treatment device to one or more remote computing resources of the distributed computing environment. Hence, the location of interest may be the location of, e.g., the center of the treatment device, or the location of a location sensor of the treatment device.

According to an embodiment, the treatment device includes multiple treatment components, such as spray nozzles for chemical treatment, electric dischargers or lasers for electromagnetic treatment, mechanical grippers for mechanical treatment or a combination thereof, to allow for targeted treatment. In case of chemical treatment, the treatment device includes one or more nozzle(s) to release treatment product to the agricultural field. Furthermore, the treatment device may comprise one or multiple sensor components, such as image capture devices like cameras, which are configured to take data, such as images, of the agricultural area as the treatment device travels through the agricultural area. Such detection components may be associated with the treatment components, such that the area of interest captured by one detection component is associated with the area of interest treated by one or more treatment components. In case of images as data set the one or more cameras may be RGB cameras, hyperspectral cameras or other suitable optical measurement devices. Each image captured in such a way may be associated with a location and as such provide a snapshot of the real time situation in the location of the agricultural field to be treated. Hence, the at least one location of interest is located at a predetermined distance and direction from the location of the treatment device and may correspond to the locations of the separate treatment components and/or the locations of the sensor components. The at least one location of interest is then, for example, computed from the location of a location sensor of the treatment device, the orientation of the treatment device and the known geometry between the location sensor and the separate treatment components and/or sensor components. As such, the sowing row direction may always be accurately determined for each one of the treatment components and/or sensor components, resulting in a high resolution and precision.

According to an embodiment, the method further comprises providing an orientation of the treatment device and determining the deviation angle between the sowing row direction and the orientation of the treatment device. This is a simple computation, comprising calculating the difference between two angles. In most cases, the deviation angle between the sowing row direction and the orientation of the treatment device is of interest to the treatment device, since the absolute orientations rarely matter. Hence, computing the deviation angle provides the required input of the treatment device. The orientation of the treatment device may be, e.g., determined from a compass of the treatment device. Additionally or alternatively, the orientation of the treatment device may be determined from previous location data of the treatment device, which allow to determine the moving direction of the treatment device, which is usually linked to the orientation of the treatment device.

According to an embodiment, the method further comprises using the determined sowing row direction and/or deviation angle for image recognition of images relating to sowing rows. By providing the sowing row direction and/or the deviation angle, the method performing the image recognition has a valuable input as to the expected direction of the sowing row. As an example, weeds may be recognized on images taken by cameras by detecting plants that grow between the sowing rows. If the sowing row direction is known to the method performing the image recognition, said weeds may be more easily detected, more accurately detected and/or the method may be performed faster. Moreover, providing the distance between the sowing rows to the method performing the image recognition may further improve the method. Said image recognition may be performed on a per-camera basis, or within an image on areas that correspond to separate treatment components. If the determination of the sowing row direction has concluded that the sowing row direction is not known for the current location of interest, said information may be provided to the image recognition method. In said case, the image recognition method may attempt to perform the image recognition without the information on the sowing row direction and/or the deviation angle or the image recognition method may not perform an image recognition at all.

According to an embodiment, the method further comprises performing an agricultural treatment based on the results of the image recognition. For example, if the image recognition has determined that weeds are present in an area covered by a sensor component or a treatment component, a corresponding treatment will be performed by the treatment component. As an example, a smart sprayer may apply an agricultural substance or an agricultural product that kills the weeds to the area where the weeds were detected. In particular, the amount of the agricultural substance or the agricultural product applied to an area may be varied based on the results of the image recognition, e.g., based on the amount of weeds in that area. As another example, a mechanical treatment component may pick the recognized weeds. As yet another example, the method for image recognition may have determined the growth stage of the plants and fertilizer may be applied according to the determined growth stage. In areas where the sowing row direction could not be determined and/or the image recognition was not able to properly function, a predetermined action may be performed by the treatment device. For example, the predetermined action may be to apply the agricultural substance or the agricultural product, in order to ensure that weeds are killed.

According to an embodiment, the method further comprises changing the moving direction of the treatment device such that the deviation angle assumes a predetermined value. As an example, for harvesting the agricultural field, the deviation angle should be zero, i.e., the treatment device, which in this example is a harvester, should move parallel to the sowing rows. As another example, for tilling the agricultural field after it has been harvested, the deviation angle should assume a predetermined value, e.g., a few degrees, such that the tilling is most effective. Using the sowing row direction or the current deviation angle as an input, it is easy to change the direction of the treatment device such that the deviation angle assumes the predetermined value.

According to another aspect of the invention, a system for determining a sowing row direction is provided. The system comprises an input unit, a database and a computing unit. Embodiments of the system are evident from the embodiments of the method according to the above description.

In particular, the input unit is configured to provide location data for at least one location of interest, the at least one location of interest being located within an agricultural field. As an example, the input unit may be an interface directly connected to a location sensor, e.g., a satellite navigation sensor. Hence, the input unit directly receives the location data. As another example, the input unit may be a network interface, receiving the location data that was acquired by the location sensor via a wired and/or wireless connection. In particular, the input unit may be located at a location remote from the agricultural field.

The database is configured to provide a sowing row information map, the sowing row information map comprising information on the sowing rows of the agricultural field with a sub-field resolution. The database may be, e.g., a hard disk on which the sowing row information map is saved.

The computing unit is configured to execute the method according to the above description. In particular, the computing unit is configured to identify the sowing row direction at the at least one location of interest based on the sowing row information map. Hence, the computing unit receives the location data for the at least one location of interest from the input unit and receives the sowing row information map from the database.

According to another aspect of the invention, a computer program element is provided. The computer program element is configured to carry out the method according to the above description when the computer program element is executed by the computing unit in the system according to the above description. Embodiments of the computer program element are evident from the embodiments of the method according to the above description.

According to another aspect of the invention, a computer readable medium is provided. The computer readable medium may be a hard disk, a data disk or a flash drive. The computer readable medium is configured to generate data to control the computing unit in the system according to the above description according to the method according to the above description. Embodiments of the computer readable medium are evident from the embodiments of the method according to the above description.

According to another aspect of the invention, a system for generating a processed sowing row information map from sowing track map is provided. The sowing track map comprises sowing track data of a sowing machine. Particularly, the sowing track map comprises the track data of the sowing machine when sowing the agricultural field. Said track data may have been recorded from data provided by a satellite navigation system, such as NAVSTAR GPS, Galileo, GLONASS or Beidou or obtained, e.g., by multilateration of mobile radio signals. As an example, the sowing track data may comprise a plurality of locations that were recorded along the track of the sowing machine. The locations may be provided as a time-ordered list such that the track of the sowing machine can be retraced. Additionally or alternatively, the sowing track data may comprise time stamps corresponding to each of the plurality of locations. Preferably, the sowing track data further comprises information on whether or not the sowing machine was sowing while moving on the agricultural field. The information whether or not the sowing machine was sowing may be included in several ways in the sowing track data. As an example, to each of the locations that were recorded along the track of the sowing machine, an identifier is recorded, identifying whether or not the sowing machine was sowing. If the sowing machine comprises a plurality of sowing units that may be individually activated, the information whether or not the sowing machine was sowing may be a list identifying the sowing status for each of the sowing units. Additionally or alternatively, only those tracks of the sowing machine during which the sowing machine was sowing may be recorded. Further information on the sowing machine, such as a layout or a width of the sowing machine, may be recorded as metadata to the sowing track map.

The processed sowing row information map may be a sowing row map. The sowing row map comprises data on the sowing rows in the agricultural field. Said data on the sowing rows is, e.g., location data for a plurality of locations along one sowing row. Alternatively, the sowing row map may be a sowing row direction map. The sowing row direction map comprises data on the direction of the sowing rows in the agricultural field. In particular, the agricultural field is divided into a plurality of zones, wherein each zone is, in particular, a polygon, and a sowing row direction is indicated for each of the zones.

The system comprises a track input unit that is configured to provide the sowing track map. The system further comprises a sowing row computing unit that is configured for calculating the processed sowing row information map from the sowing track map.

As an example, the sowing row computing unit may trace the track of the sowing machine and, if the sowing machine was sowing at given location, record the corresponding sowing row data. In particular, the sowing row computing unit may have information about the layout and the width of the sowing machine, such that the sowing row computing unit may determine the location of individual sowing units based on the location and the orientation of the sowing machine and the known location of the sowing units with respect to the sowing machine. The orientation of the sowing machine may be, e.g., determined from the moving direction of the sowing machine, which in turn may be determined from the change in location of the sowing machine. Hence, for each sowing unit, a sowing row will be determined. Naturally, the sowing row will only be recorded if it is indicated that the corresponding sowing unit was sowing at the given time.

As another example, the sowing row computing unit may, for a plurality of locations of the agricultural field, e.g., for every pixel of a map of the agricultural field, search the sowing track map for the track being closest to location. If information on whether the sowing machine was sowing or not is available, only the tracks for which sowing was active will be considered. The corresponding direction of the sowing row will then be recorded for that location. Locations with an identical or a very similar sowing row direction, e.g., deviating from one another by a predetermined value of at most 5°, particularly at most 2°, most particularly at most 1°, may be combined into one zone with a common sowing row direction.

Moreover, the system comprises an output unit for outputting the processed sowing row information map.

In particular, the system for generating a processed sowing row information map may be at a remote location. More particularly, the system may be a cloud computing system. In this case, the track input unit is a network interface, receiving the sowing track map that has been recorded by a sowing machine via a wired and/or wireless connection. Also, the output unit may be a network interface, broadcasting the processed sowing row information map via a wired and/or wireless connection. The processed sowing row information map may then be used, e.g., as input for a system for determining the sowing row direction according to the above description.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows a sowing track map;

FIG. 2 shows a sowing row map;

FIG. 3 shows a sowing row direction map;

FIG. 4 shows a system for generating a processed sowing row information map;

FIG. 5 shows a system for determining a sowing row direction;

FIG. 6 schematically shows a smart sprayer;

FIG. 7 schematically shows a smart sprayer moving on an agricultural field;

FIG. 8 shows a flowchart of an embodiment of a method for determining a sowing row direction;

FIG. 9 shows a flowchart of another embodiment of a method for determining a sowing row direction;

FIG. 10 shows a flowchart of yet another embodiment of a method for determining a sowing row direction; and

FIG. 11 shows a flowchart of yet another embodiment of a method for determining a sowing row direction.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

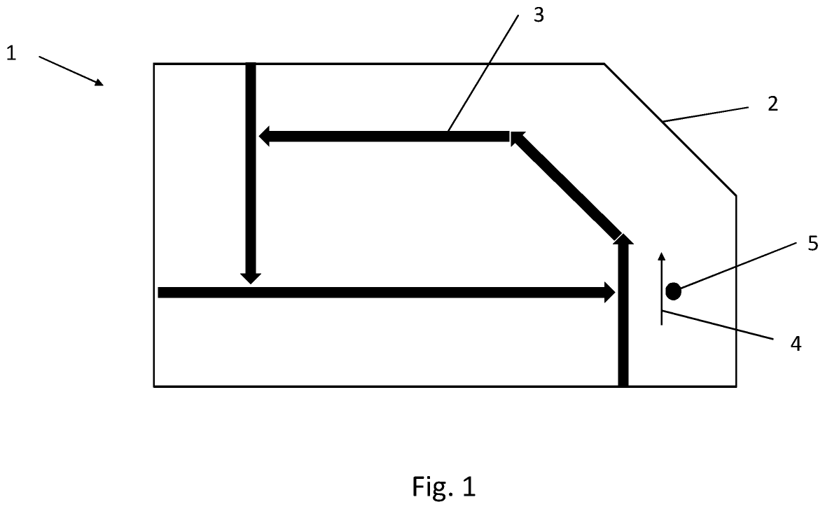

FIG. 1 shows an exemplary sowing track map 1 for an agricultural field 2. The sowing track map 1 comprises sowing track data 3 of a sowing machine when sowing the agricultural field 2. Said sowing track data 3 may have been recorded from data provided by a satellite navigation system, such as NAVSTAR GPS, Galileo, GLONASS or Beidou or obtained, e.g., by multilateration of mobile radio signals. The sowing track data 3 comprises a plurality of locations that were recorded along the track of the sowing machine, here indicate as arrows. In FIG. 1, only the tracks are shown when at least one sowing unit of the sowing machine was sowing. Alternatively, all tracks could be included, an additional information would have to be provided for each track or each part of a track, whether or not sowing of the sowing machine was active. If the sowing machine comprises a plurality of sowing units that may be individually activated, also information on whether or not the sowing machine was sowing may be included as information pertaining to a track or a part of a track. Further information on the sowing machine, such as a layout or a width of the sowing machine, may be recorded as metadata to the sowing track map 1.

A sowing row direction 4 for a location of interest 5 may be determined from the direction of the sowing track 3 closest to the location of interest 5. Finding said sowing track 3 being closest to the location of interest 5 is computationally easy. If the sowing track data 3 also comprises information on whether or not the sowing machine was sowing while moving on the agricultural field 2, only the sowing tracks 3 during which the sowing machine was sowing will be considered. If, within a predetermined radius around the location of interest, wherein the predetermined radius is, in particular, one half of the width of the sowing machine, no sowing track 3 can be found, it is assumed that there was no sowing at the location of interest and instead of the sowing row direction 4, a corresponding message will be returned. Also, if, within the predetermined radius more than one sowing track 3 is found and the directions of said sowing tracks 3 differ from one another, it is unclear whether the sowing row follows one or the other direction or whether sowing was performed, for whichever reason, in two directions. Hence, it is also unclear whether sowing was performed in one or the other or both directions and a corresponding message will be returned instead of a sowing row direction 4.

An example for sowing track raw data is given in the Table below.

Sowing unit active

| Time | Location | #1 | #2 | . . . | #N |
|---|---|---|---|---|---|
| 9:10 | 49.496584 N; 8.430273 E | yes | yes | . . . | yes |
| 9:12 | 49.495827 N; 8.427133 E | no | yes | . . . | no |
| . . . | . . . | . . . | . . . | . . . | . . . |

Here, the locations of the sowing machine and the corresponding times have been recorded. Also, for each of the N sowing units, it has been recorded whether the sowing unit was active or not. The latter information may also be appended to the sowing tracks 3 of the sowing track map 1.

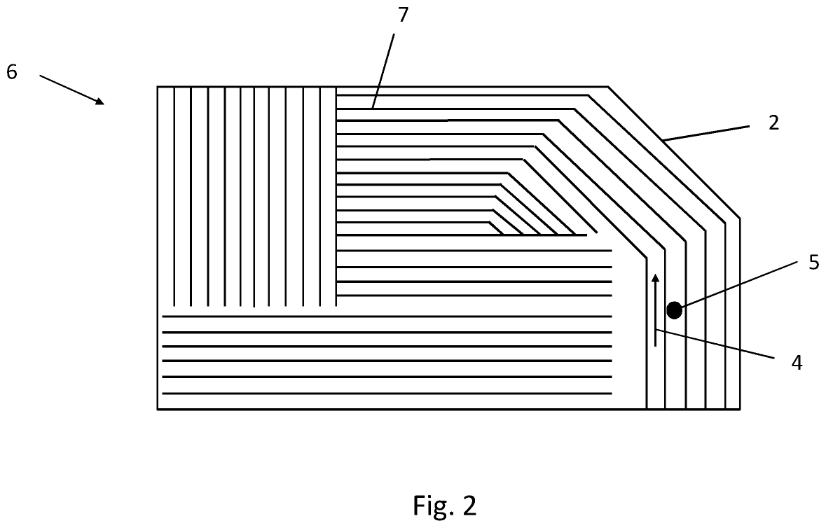

FIG. 2 shows an exemplary sowing row map 6, showing the individual sowing rows 7. The sowing row map 6 may have been obtained from the sowing track map 1 of FIG. 1 by tracing the sowing tracks 3 of the sowing machine and, if the sowing machine was sowing at given location, record the corresponding sowing row data 7. In particular, information about the layout and the width of the sowing machine may be used to determine the location of individual sowing units based on the location and the orientation of the sowing machine and the known location of the sowing units with respect to the sowing machine. The orientation of the sowing machine may be, e.g., determined from the moving direction of the sowing machine, which may be directly determined from the sowing tracks 3. Hence, for each sowing unit, a sowing row 7 has been determined using the sowing tracks 3. Naturally, the sowing row 7 will only be recorded if it is indicated that the corresponding sowing unit was sowing at the given time.

Using the sowing row map 6, the sowing row direction 4 at the location of interest 5 may be determined. Such determination is performed, in particular, from the direction of the sowing row 7 closest to the location of interest 5. Finding said sowing row 7 being closest to the location of interest is computationally easy. If, within a predetermined radius around the location of interest 5, wherein the predetermined radius is, in particular, the typical spacing between two sowing rows 7 or one half of the spacing between two sowing rows 7, no sowing row 7 can be found, it is assumed that there is no sowing row 7 at the location of interest 5 and instead of the sowing direction 4, a corresponding message will be returned.

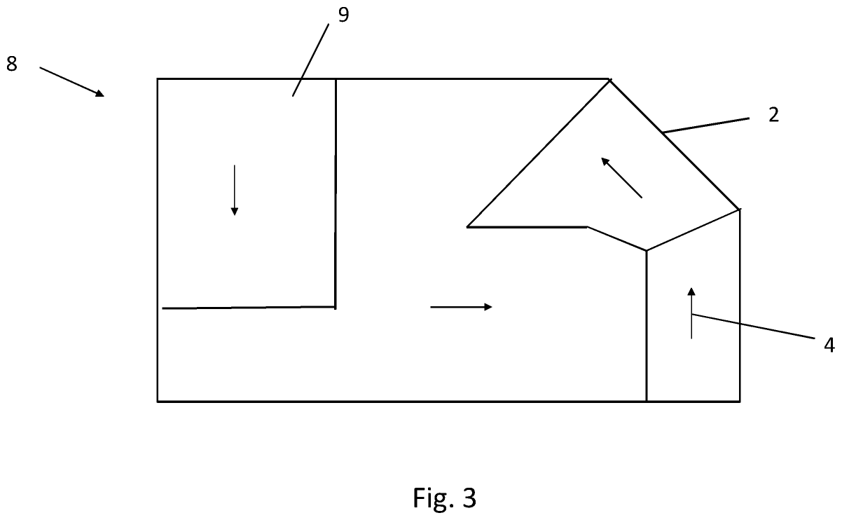

FIG. 3 shows an exemplary sowing row direction map 8. The sowing row direction map 8 comprises the sowing row direction 4 for each of a plurality of zones 9, wherein the zones 9 are polygons into which the agricultural field 2 has been divided. Hence, each of the plurality of zones 9 has one sowing row direction 4. Determining the sowing row direction 4 for a location of interest 5 can then easily be performed by retrieving the sowing row direction 4 of the zone 9 containing the location of interest 5.

The sowing row direction map 8 may be determined from a sowing track map 1. For example, for a plurality of locations of the agricultural field 2, e.g., for every pixel of a map of the agricultural field 2, the sowing track map 1 is searched for the track 3 being closest to location. If information on whether the sowing machine was sowing or not is available, only the tracks 3 for which sowing was active will be considered. The corresponding sowing row direction 4 will then be recorded for that location. Locations with an identical or a very similar sowing row direction 4, e.g., deviating from one another by a predetermined value of at most 5°, particularly at most 2°, most particularly at most 1°, are then combined into one zone 9 with a common sowing row direction 4.

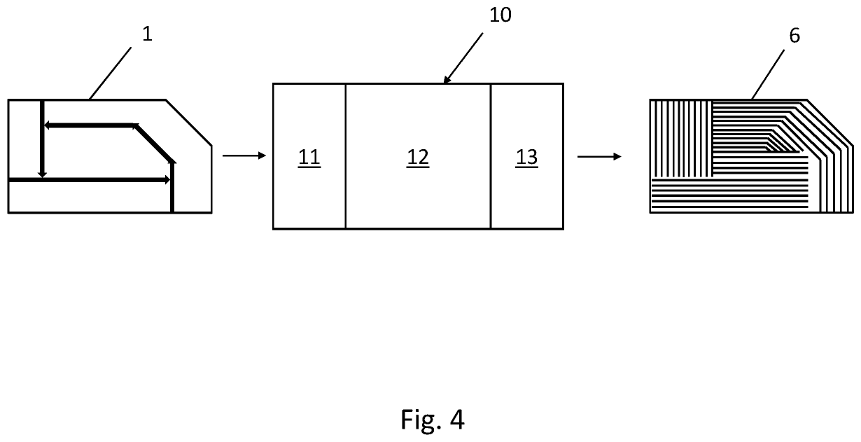

FIG. 4 shows an embodiment of a system 10 for generating a processed sowing row information map from a sowing track map 1. The processed sowing row map may be a sowing row direction map 8 or, as shown in this embodiment, a sowing row map 6. The system 10 comprises a track input unit 11, a sowing row computing unit 12 and an output unit 13. The track input unit 11 receives the sowing track map 1 or similar sowing track information data. As an example, the track input unit 11 may receive the sowing track map 1 directly from a sowing machine, via a wired and/or wireless connection.

The sowing row computing unit 12 calculates the sowing row map 6 from the sowing track map 1. Details on said calculation have been described above. Finally, the output unit 13 broadcasts the sowing row map 6, e.g., to a treatment device or to a system for determining a sowing row direction.

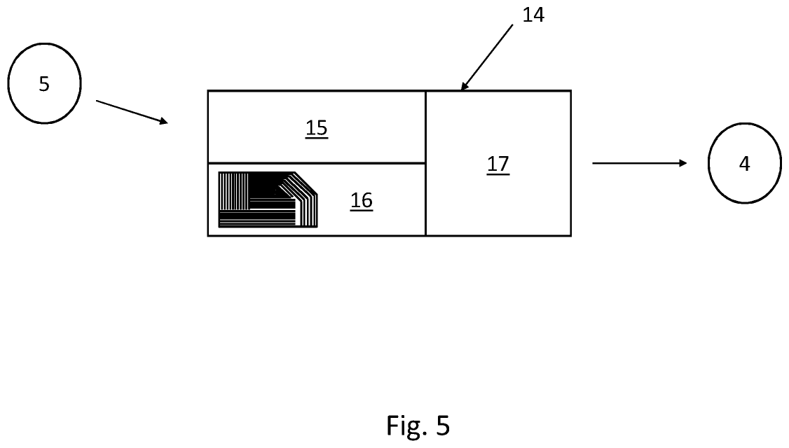

FIG. 5 shows an embodiment of a system 14 for determining a sowing row direction 4. The system 14 comprises an input unit 15, a database 16 and computing unit 17. The input unit 15 receives location data for at least one location of interest 5. Said location data may be provided by a location sensor, based, e.g., on a satellite navigation system, of a treatment device. The database 16 stores a sowing row information map, which is shown as a sowing row map 6 in this embodiment. The database 16 may store the sowing row map 6 on a hard disk, a data disk or a flash drive. The computing unit 17 has access to the location data for the location of interest 5 and the sowing row map 6 and computes the sowing row direction 4 at the location of interest 5 based on said input. Details of this calculation have been described above.

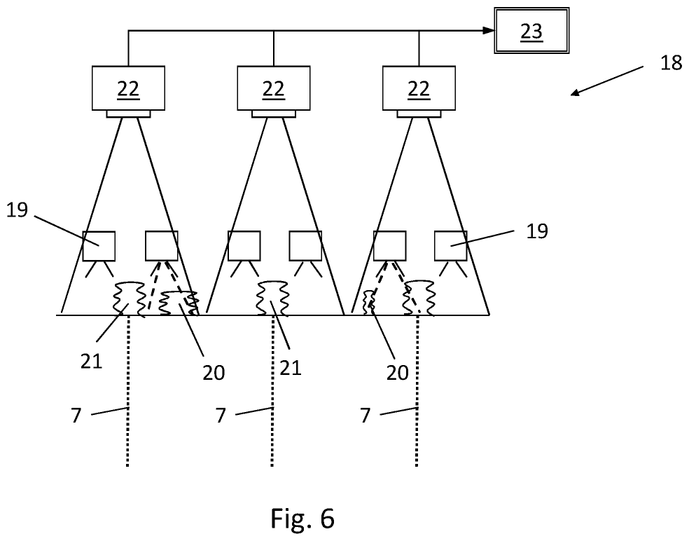

FIG. 6 schematically shows a smart sprayer 18 as one example of a treatment device. The smart sprayer 18 may be attached to a tractor, may be self-propelled, but may also be part of an aircraft, e.g., an airplane or a drone. The smart sprayer 18 is adapted to spray herbicides through nozzles 19. In order to achieve a local impact, each of the nozzles 19 can be turned on and off separately. Moreover, even the amount of herbicide to be applied may be adjusted per nozzle 19.

In order to distinguish weeds 20 from the crop 21, the smart sprayer 18 comprises cameras 22. Here, one camera 22 covers the area that can be sprayed by two nozzles 19. The cameras 22 take pictures of the areas assigned to the cameras 22 and an image recognition 23 system performs the image recognition. This is done by identifying areas in which plants grow outside the sowing rows 7. Since the crop 21 is supposed to grow only along the sowing rows 7, plants growing outside the sowing rows 7 are assumed to be weeds 20. In order to perform this image recognition, the image recognition system 23 needs the sowing row direction 4 as an input. While an image recognition may also be performed without the sowing row direction 4 as an input, such an image recognition is slower and less accurate.

Once the image recognition system 23 has recognized a weed 20, the nozzle 19 corresponding to the area of the recognized weed 20 is activated to spray herbicides, indicated by the dashed lines. Hence, providing a sowing row direction 4 and therefore improving the image recognition allows a precise and local treatment of weeds 20.

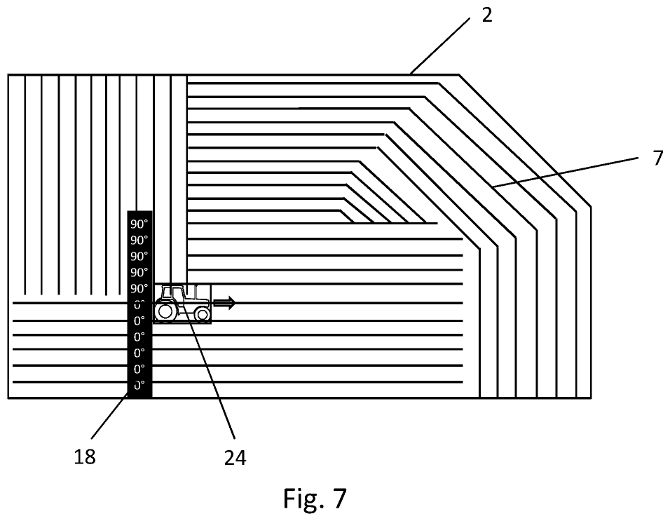

FIG. 7 schematically shows a smart sprayer 18 being pulled by a tractor 24 over the agricultural field 2. The sowing rows 7 are also shown. The numbers shown in the smart sprayer correspond to a deviation angle of the sowing row direction 4 and the moving direction of the smart sprayer 18. It can be seen that the deviation angle varies along the smart sprayer 18, depending on the sowing row direction 4 indicated by the sowing rows 7. Hence, an accurate use of herbicides is enabled.

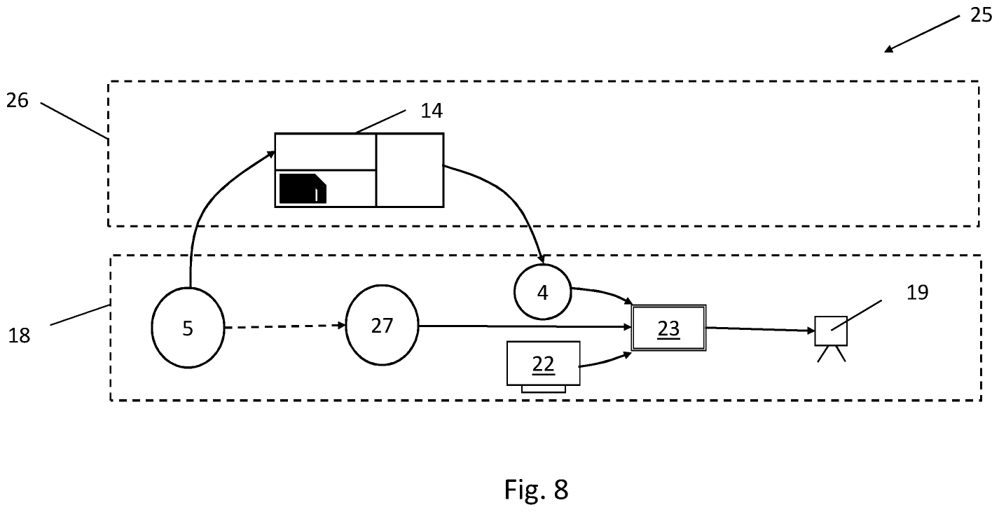

FIG. 8 shows a flowchart of an embodiment of a method 25 for determining a sowing row direction 4 and performing an agricultural treatment, indicated by a nozzle 19, based on the results of an image recognition using the determined sowing row direction 4.

The method is split into two parts: one part that is performed by a treatment device 18, such as a smart sprayer. The other part is performed by a remote computing system 26, which may be cloud computing system.

The treatment device generates location data 5, e.g., based on a satellite navigation system. Said location data 5 is transferred to the remote computing system 26, where a system for determining a sowing row direction 14 determines the sowing row direction 4 at the location of interest 5, based on a sowing row information map. The determined sowing row direction 4 is then transferred back to the treatment device 18. The treatment device further determines an orientation 27 of the treatment device 18, either, e.g., by a compass, or, as shown by the dashed line, from the location data 5. The sowing row direction 4, the orientation of the treatment device 27 and images obtained from at least one camera 22 are then used as input for the image recognition system 23. Alternatively, a deviation angle between the sowing row direction 4 and the orientation 27 of the treatment device together with the images obtained from the at least one camera 22 may be used as input for the image recognition system 23. The image recognition system 23 then recognizes weeds based on the input and provides a control signal for the appropriate nozzle 19.

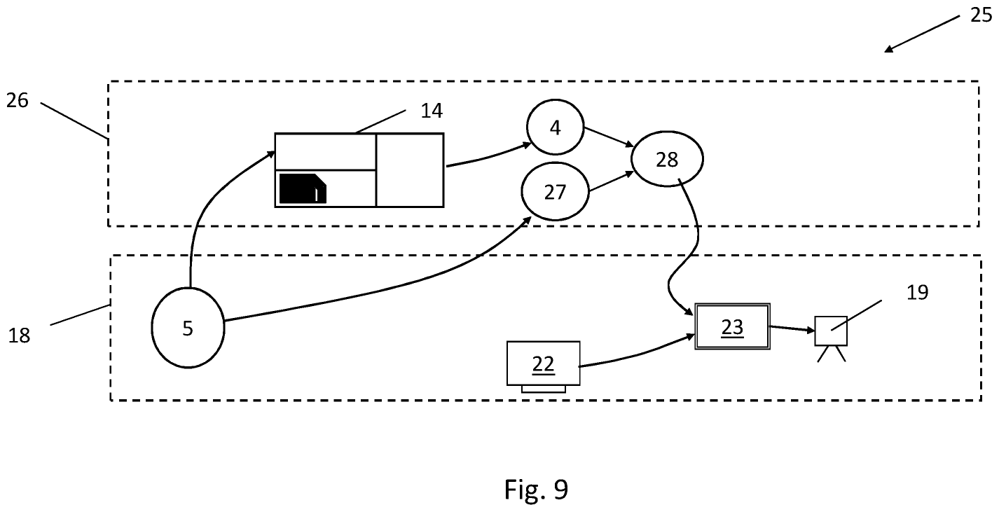

FIG. 9 shows a flowchart of an alternative embodiment of a method 25 for determining a sowing row direction 4 and performing an agricultural treatment. Here, the remote computing system 26 uses the received location data 5 to determine the orientation 27 of the treatment device 18, computes the deviation angle 28 from the sowing row direction 4 and the orientation 27 of the treatment device 18 and provides the deviation angle 28 to the treatment device 18. The treatment device 18 then uses the deviation angle 28 and the images obtained by the camera 22 to recognize weeds and to provide the resulting control signal to the appropriate nozzle 19.

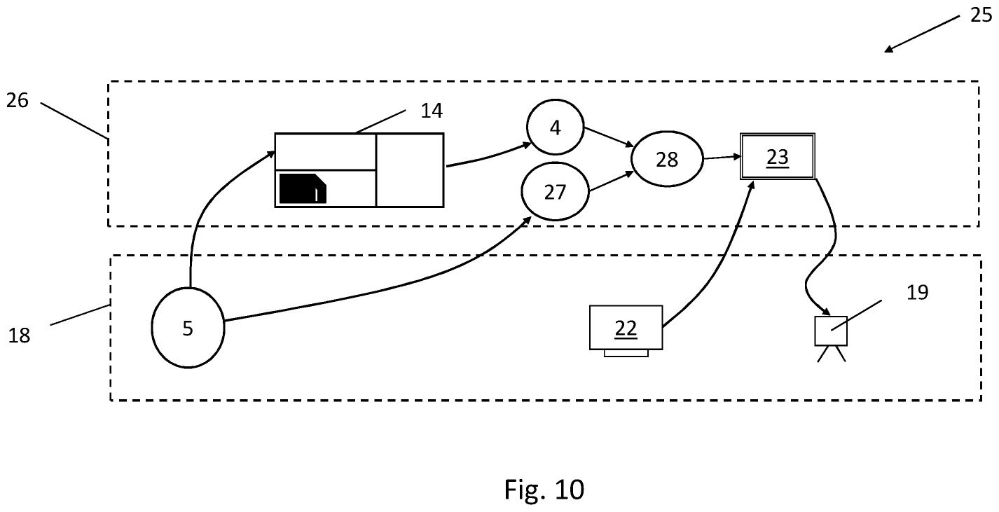

FIG. 10 shows a flowchart of yet another alternative embodiment of a method 25 for determining a sowing row direction 4 and performing an agricultural treatment. Here, the remote computing system 26 also receives the images obtained from the cameras 22. The image recognition system 23 is allocated to the remote computing system 26 and takes the computed deviation angle 28 and the images obtained from the cameras 22 as input to recognize weeds and to generate a control signal, which is then transferred to the treatment device 18 in order to operate the nozzles 19.

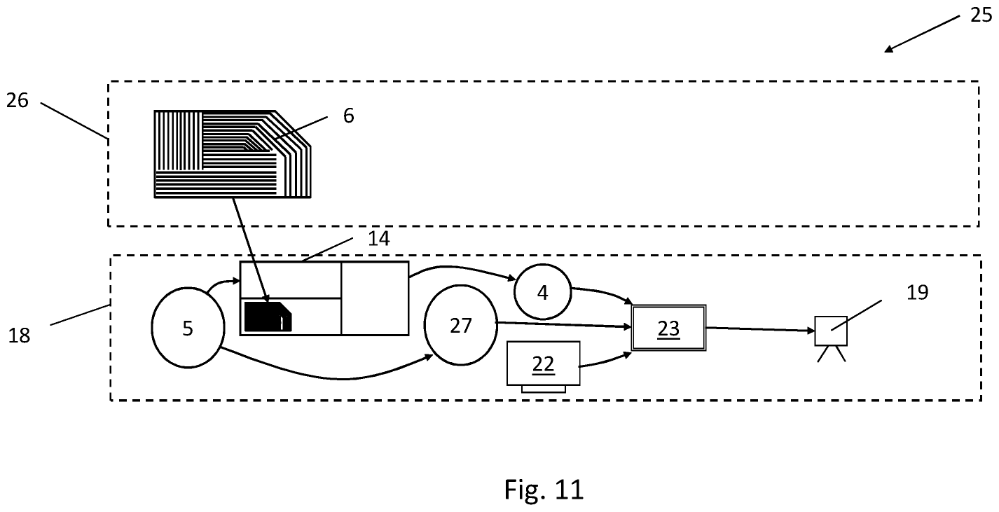

FIG. 11 shows a flowchart of yet another alternative embodiment of a method 25 for determining a sowing row direction 4 and performing an agricultural treatment. Here, the remote computing system 26 only provides the sowing row information map, shown as sowing row map 6, to the treatment device 18. All other steps, in particular the computation of the sowing row direction 4 and the image recognition are performed by the treatment device 18.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for determining a sowing row direction (4), the method comprising:
providing location data for at least one location of interest (5), the at least one location of interest (5) being located within an agricultural field (2);
providing a sowing row information map (1; 6; 8), the sowing row information map (1; 6; 8) comprising information on the sowing rows (7) of the agricultural field (2) with a sub-field resolution; and
identifying the sowing row direction (4) at the at least one location of interest (5) based on the sowing row information map (1; 6; 8).

2. The method according to claim 1, wherein the sowing row information map (1; 6; 8) is a sowing track map (1) comprising sowing track data (3) of a sowing machine and the sowing row direction (4) is determined, in particular, from the direction of the sowing track closest to the at least one location of interest (5).

3. The method according to claim 1, wherein the sowing row information map (1; 6; 8) is a sowing row map (6) comprising data on the sowing rows (7) and the sowing row direction (4) is determined, in particular, from the direction of the sowing row (7) closest to the at least one location of interest (5).

4. The method according to claim 1, wherein the sowing row information map (1; 6; 8) is a sowing row direction map (8) indicating a sowing row direction for each of a plurality of zones of the agricultural field and the sowing row direction (4) is determined, in particular, from the sowing row direction (4) indicated at the at least one location of interest (5).

5. The method according to claim 1, wherein the at least one location of interest (5) is the location of a treatment device (18).

6. The method according to claim 1, wherein the at least one location of interest (5) is located at a predetermined distance and direction from the location of the treatment device (18).

7. The method according to claim 1, further comprising:
providing an orientation (27) of the treatment device (18); and
determining the deviation angle (28) between the sowing row direction (4) and the orientation (27) of the treatment device (18).

8. The method according to claim 1, further comprising:
using the determined sowing row direction (4) and/or deviation angle (28) for image recognition of images relating to sowing rows (7).

9. The method according to claim 8, further comprising:
performing an agricultural treatment based on the results of the image recognition.

10. The method according to claim 1, further comprising:
changing the moving direction of the treatment device (18) such that the deviation angle (28) assumes a predetermined value.

11. A system for determining a sowing row direction (4), the system (14) comprising:
an input unit (15) for providing location data for at least one location of interest (5), the at least one location of interest (5) being located within an agricultural field (2);
a database (16) for providing a sowing row information map (1; 6; 8), the sowing row information map (1; 6; 8) comprising information on the sowing rows (7) of the agricultural field (2) with a sub-field resolution; and
a computing unit (17) configured to execute the method according to claim 1.

12. A non-transitory computer-readable medium having instructions encoded thereon which, when executed by a computing unit in a system, cause the computing unit to carry out the method according to claim 1.

13. (canceled)

14. A system for generating a processed sowing row information map (6; 8) from a sowing track map (1), the system (10) comprising:
a track input unit (11) for providing the sowing track map (1);
a sowing row computing unit (12) for calculating the processed sowing row information map (6; 8) from the sowing track map (1); and
an output unit (13) for outputting the processed sowing row information map (6; 8).
